(19) United States
(12) Patent Application Publication
(10) Pub. No.: US 2022/0396481 A1
(43) Pub. Date: Dec. 15, 2022

(54) NON-AQUEOUS HYDROGEN PEROXIDE SOLUTION AND METHOD OF MANUFACTURE

(71) Applicant: Lyondell Chemical Technology, L.P., Houston, TX (US)

(72) Inventors: Ha H. Nguyen, Houston, TX (US); Randy Magadan, Houston, TX (US)

(73) Assignee: Lyondell Chemical Technology, L.P., Houston, TX (US)

(21) Appl. No.: 17/831,062

(22) Filed: Jun. 2, 2022

Related U.S. Application Data
(60) Provisional application No. 63/208,850, filed on Jun. 9, 2021.

(51) Int. Cl. C01B 15/026; C01B 15/017

(52) U.S. Cl. CPC C01B 15/026; C01B 15/017

(57) ABSTRACT

Disclosed herein are hydrogen peroxide solutions in non-aqueous solvents and processes for manufacturing the non-aqueous hydrogen peroxide solutions starting from an aqueous hydrogen peroxide solution. Exemplary non-aqueous solvents include alcohols such as tert-butyl alcohol. It has been discovered that when tert-butyl alcohol and an aqueous hydrogen peroxide solution are combined in certain ratios, and water from this mixture is removed by an azeotropic distillation, tert-butyl alcohol-based hydrogen peroxide solution comprising less than 1 wt % water are readily achieved.

### CROSS REFERENCE TO RELATED APPLICATIONS

This application claims the benefit of priority to U.S. Provisional Patent Application No. 63/208,850, filed on Jun. 9, 2021, which is incorporated herein by reference in its entirety.

### TECHNICAL FIELD

This disclosure relates to non-aqueous hydrogen peroxide solutions such as alcohol solutions and methods of manufacturing the non-aqueous hydrogen peroxide solutions.

### BACKGROUND OF THE DISCLOSURE

Hydrogen peroxide (H₂O₂) is a widely-used compound that finds many industrial and laboratory applications as an oxidizer, bleaching agent, antimicrobial and the like. Peroxide compounds such as H₂O₂ are characterized by an unstable oxygen-oxygen single bond from which peroxide compounds derive their reactivity and utility. Hydrogen peroxide is commercially-available in aqueous solution, ranging for example, from about 30 wt % in water to about 70 wt % in water. Even higher concentrations of hydrogen peroxide are available under strict regulatory provisions, due to their high reactivity.

Despite the wide range of applications for hydrogen peroxide solutions, the high concentration of water in current commercial products may prevent their use for certain functions in which water is undesirable. For example, high concentration of water can have an undesirable impact such as, for example, solubility issues, byproduct formations, or separation processes. For example, in a Hydrogen Peroxide Propylene Oxide (HPPO) process, where hydrogen peroxide reacts with propylene to form propylene oxide, initially having high concentration of water will lead to a higher amount of undesired byproduct propylene glycol from the reaction between propylene oxide and water. Therefore, there is a need for non-aqueous solutions of hydrogen peroxide that can be used in applications for which aqueous hydrogen peroxide is undesirable, and there is a need for methods of manufacturing such non-aqueous hydrogen peroxide solutions.

### SUMMARY OF THE DISCLOSURE

This disclosure provides new hydrogen peroxide solutions and processes for making or manufacturing the hydrogen peroxide solutions, in which the water in an aqueous hydrogen peroxide solution is replaced or largely replaced by a non-aqueous solvent such as an alcohol. Any alcohol, for example tert-butyl alcohol (TBA), which can form an azeotropic mixture with water can be used. The disclosed process provides a solution of hydrogen peroxide in the non-aqueous solvent such as an alcohol, in which the water content of the solution can be very low, for example, less than 1 wt %. Such solutions may be useful in applications which would derive benefit from the presence of lower concentrations of amounts of water.

Therefore, there is provided a method of forming a hydrogen peroxide solution, the method comprising: combining an non-aqueous solvent and an aqueous hydrogen peroxide solution to form a first mixture; and removing water from the first mixture to obtain an non-aqueous solvent-based hydrogen peroxide solution. In embodiments, an alcohol, for example tert-butyl alcohol (TBA), can be used as the non-aqueous solvent.

The use of TBA allows integration of TBA sources and the processes which use the non-aqueous solvent-based hydrogen peroxide solution. The TBA used can be recycled back to the first process which already has a system in place for TBA separation and purification. For example, this can be realized in an integration of a Propylene Oxide tert-butyl alcohol (POTBA) plant and an HPPO plant. TBA from the POTBA plant is used to make the TBA-H₂O₂ solution with low water concentrations which then is fed to the HPPO plant. The TBA separated from the HPPO plant is recycled back to the POTBA plant for separation and purification. In this scheme, the HPPO plant does not need a TBA purification and recycling system, thus reducing the capital investment.

In embodiments, this disclosure also provides a continuous process for making a non-aqueous hydrogen peroxide solution, the process comprising:
a) combining a fresh non-aqueous solvent stream and an aqueous hydrogen peroxide solution stream in a mixing vessel to form a first mixture (10) comprising the non-aqueous solvent, hydrogen peroxide, and water, each having a respective concentration in the first mixture (10);
b) separating the first mixture into [1] a first stream (20) comprising a first portion of the non-aqueous solvent and a majority of the water present in the first mixture and [2] a second stream (30) comprising a second portion of the non-aqueous solvent and a majority of the hydrogen peroxide present in the first mixture; and
c) separating the first stream (20) into a non-aqueous solvent fraction and a water fraction.

In some embodiments, this continuous process may further comprise the step of:
d) recycling at least a portion of the non-aqueous solvent fraction of the first stream (20) into the fresh non-aqueous solvent stream of step a).

This continuous process may further comprise the step of:
e) combining at least a portion of the non-aqueous solvent fraction of the first stream (20) with the second stream (30) to form a second mixture (40) comprising the non-aqueous solvent and hydrogen peroxide, wherein the hydrogen peroxide is present in a lower concentration in the second mixture (40) than in the second stream (30).

In further embodiments, this disclosure also provides a chemical facility which can perform the continuous process, the chemical facility comprising:
a) a first mixing vessel having a first mixing vessel discharge port, the first mixing vessel in fluid communication with a fresh non-aqueous solvent source and an aqueous hydrogen peroxide solution source, wherein a first mixture (10) comprising the non-aqueous solvent, hydrogen peroxide, and water, each having a respective concentration in the first mixture (10), is formed in the first mixing vessel;
b) a distillation unit configured to receive the first mixture (10) from the first mixing vessel discharge port and effect an azeotropic distillation of the first mixture (10) to provide a first stream (20) as an overhead fraction and a second stream (30) as a bottom fraction in the distillation unit; and
c) a separation unit configured to receive the first stream (20) from the distillation unit and separate the first stream (20) into a non-aqueous solvent fraction and a water fraction, and configured to return at least a portion of the non-aqueous solvent fraction into the fresh non-aqueous solvent source of step a).

In some embodiments, the separation unit of this chemical facility may be configured to return at least a portion of the non-aqueous solvent fraction into the fresh non-aqueous solvent source of step a).

This chemical facility may further comprise:
d) a second mixing vessel configured to receive the second stream (30) from the distillation unit and at least a portion of the non-aqueous solvent fraction of the first stream (20) to form a second mixture (40) comprising the non-aqueous solvent and hydrogen peroxide, wherein the hydrogen peroxide is present in a lower concentration in the second mixture (40) than in the second stream (30).

In a further aspect, this disclosure also provides a method of making a hydrogen peroxide solution, the method comprising:
a) combining tert-butyl alcohol and an aqueous hydrogen peroxide solution to form a first mixture comprising tert-butyl alcohol, hydrogen peroxide, and water, wherein the tert-butyl alcohol-to-water ratio in the first mixture is at least 18:1 (wt/wt); and
b) removing water from the first mixture by an azeotropic distillation under vacuum to obtain a tert-butyl alcohol-based hydrogen peroxide solution comprising less than 1 wt % water.

These and other aspects, embodiments, and features of the processes, methods, facilities, and compositions are described more fully in the Detailed Description and claims and further disclosure such as the Examples provided herein.

### BRIEF DESCRIPTION OF THE DRAWINGS

FIG. 1 provides a schematic illustration of an embodiment of the disclosure, specifically, a continuous process to form a hydrogen peroxide-alcohol solution using TBA as the alcohol, as described in this disclosure.

FIG. 2 illustrates a plot of the weight ratio of TBA to water (wt/wt) (x-axis) versus the concentration of water in the final TBA-H₂O₂ mixture (wt %) data set out in Table 1, which demonstrates how increasing the proportion of TBA added to an initial aqueous hydrogen peroxide solution removes increasing amounts of water to provide a final TBA-hydrogen peroxide solution with very low concentration of water.

FIG. 3 provides a schematic illustration of an embodiment of the disclosure, specifically, an integration of a POTBA plant and an HPPO plant in which the TBA from the POTBA plant is used to make the TBA-H₂O₂ solution which then is used in the HPPO plant to make propylene oxide (PO). The TBA from the water removal step and subsequent separation steps is recycled back to the POTBA plant for separation and purification.

### DETAILED DESCRIPTION OF THE DISCLOSURE

Aspects of this disclosure provide for non-aqueous hydrogen peroxide solutions such as alcohol solutions, and processes for manufacturing these non-aqueous hydrogen peroxide solutions. Many aspects and examples presented in this disclosure are described in terms of alcohol solutions of hydrogen peroxide, for example, tert-butyl alcohol (TBA or tertiary-butyl alcohol) solutions. However, this disclosure is also applicable to other non-aqueous solvents, for example, other non-aqueous solvents which can form an azeotrope with water.

The term “non-aqueous” solvent is used in this disclosure rather than “anhydrous” solvent to reflect that the solvents used according to this disclosure can contain small amounts or trace amounts of water. Therefore, while anhydrous solvents can be used according to the disclosure, the solvents do not have to be strictly anhydrous.

In some embodiments, the formation of a hydrogen peroxide solution in alcohol can be carried out by first combining an aqueous hydrogen peroxide solution with an alcohol such as TBA, to form a mixture of TBA, hydrogen peroxide, and water. This mixture is subsequently subjected to a separation process to remove the water. Applicable separation processes include but are not limited to distillation processes, membrane separation processes, or a combination thereof.

In embodiments of this disclosure, the separation process used to form the hydrogen peroxide solution in TBA can be carried out by distillation, including vacuum distillation, that is, a distillation conducted under vacuum. In this distillation process, water is removed overhead with TBA, while hydrogen peroxide remains in the bottom as a TBA solution. The distillation process can be a continuous process. The amount of TBA used in the process, and the parameters of the distillation process such as the distillation temperature and pressure, can be manipulated to achieve the desired concentration of the three components, hydrogen peroxide, water, and TBA in the final mixture. For example, a sufficiently large weight percent excess of TBA compared to the weight percent of water in the feed can be used so that the bottom solution contains almost exclusively hydrogen peroxide and TBA and retains low concentrations of water, such as less than about 1 wt % water.

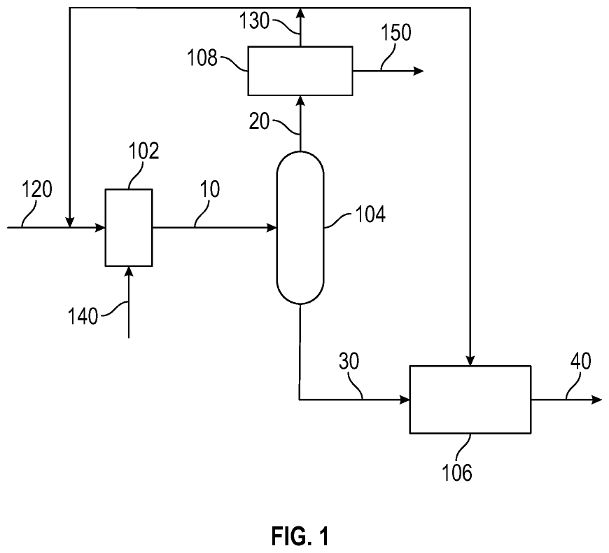

In embodiments, the distillation process can be a continuous process such as illustrated in FIG. 1, which can achieve the desired hydrogen peroxide-alcohol mixture and the desired H₂O₂ concentration. In FIG. 1, various mixing, distillation, dilution, and separation steps are show as Steps (102) through Steps (108), and while FIG. 1 is illustrated using tert-butyl alcohol (TBA), it is to be understood that any of the alcohols or other non-aqueous solvents disclosed herein can be used in an analogous manner.

In Step (102), fresh (non-recycled) alcohol (120) shown as TBA in FIG. 1 is combined or mixed with a recycled TBA stream (130), and this combination TBA stream is then combined or mixed with the initial H₂O₂ solution in water (140), forming a tertiary mixture of TBA, H₂O₂, and water (10). The initial H₂O₂ solution in water (140) can be selected from any concentration of hydrogen peroxide in water. Mixing of this ternary solution (10) can be carried out using any type of mixer if desired, and the mixing can be conducted without heating and at atmospheric pressure as desired. The ratio of TBA to water determines the effectiveness of the water removal step at Step (104), with greater concentrations of TBA resulting in more effective H₂O removal.

Step (104) of FIG. 1 illustrates a separation step, in which the formed tertiary mixture (10) is separated in a distillation column. The distillation column can be operated under vacuum, therefore at pressures less than atmospheric pressure. Column configurations for such distillations are well understood by those of ordinary skill in the art. In an aspect, vacuum pressure is selected to reduce the temperature at the reboiler which provides heat to the bottom of the distillation column in order to reduce the boiling temperature of the tertiary mixture (10) which may lead to H₂O₂ decomposition. In Step (104) the water and TBA are removed overhead (20), which then can be directed to a recovery system (108) to separate TBA from the water-TBA mixture and recycle the recovered TBA (130) back to the mixing Step (102). As the water is removed overhead with TBA, the hydrogen peroxide remains in the bottom as a TBA solution. The final concentration of H₂O₂ in the H₂O₂-TBA mixture in the bottom stream (30) be controlled by adjusting the bottom flow rate. Thus, adjusting the bottom flow rate controls the amount of TBA remaining in bottom stream, thereby controlling the concentration of H₂O₂ in the H₂O₂-TBA mixture. Separation Step (104) can be carried out using any method in the art, such as azeotropic distillation, membrane separation, or a combination, to provide the separation shown at Step (104) of FIG. 1.

In some embodiments, the overall continuous process can include a dilution step, shown as Step (106) of FIG. 1. In the Step (106) dilution step, the H₂O₂ concentration in the H₂O₂-TBA mixture in the bottom stream (30) can then adjusted to form the H₂O₂-TBA mixture shown as (40), in which the H₂O₂ concentration has been adjusted to a desired lower level by adding more TBA in dilution Step (106). The TBA stream used for this dilution Step (106) can be from the recycled TBA (130) generated in Step (108) as shown in FIG. 1 or can be a TBA stream.

Step (108) of FIG. 1 illustrates a TBA-water separation in which the TBA-water mixture (20) removed overhead in distillation Step (104) can be separated into a TBA stream (130) and a final water stream (150). In an embodiment as shown in FIG. 1, the TBA recovered in Step (108) then may be recycled back to the mixing Step (102) of the continuous process and/or used in dilution Step (106). The TBA-water (20) entering Step (108) can be separated using any method in the art, such as azeotropic distillation, membrane separation, or a combination, to provide the TBA stream for recycling or use elsewhere and the final water stream.

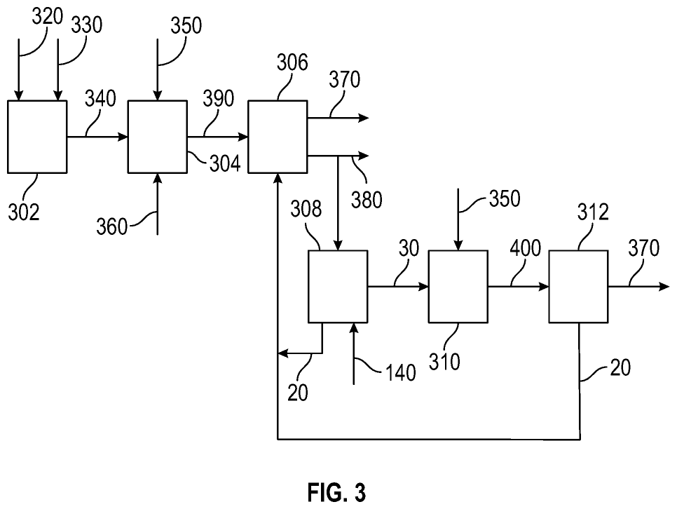

In some embodiments, an integration of a TBA source and TBA-H₂O₂ user can be a continuous process such as illustrated in FIG. 3, which shows an integration of a POTBA plant (302, 304, 306) and an HPPO plant (308, 310, 312). The POTBA plant consists of various reaction, mixing, distillation, dilution, and separation steps are shown as Steps (302) through Steps (306) in FIG. 3. The HPPO plant consists of various reaction, mixing, distillation, dilution, and separation steps are shown as Steps (308) through Steps (312) in FIG. 3.

In Step (302), isobutane (320) reacts with oxygen (330) to form an organic hydroperoxide solution (340), which is then separated and purified.

In Step (304), the organic hydroperoxide solution (340) from Step (302) reacts with propylene (350) and catalyst (360) to form two main products, propylene oxide (PO) (370) and tert-butyl alcohol (TBA) (380) as a mixture (390).

In Step (306), the two main products PO (370) and TBA (380) are separated and purified. Some portion of the TBA (380) product is sent to the HPPO plant (308, 310, 312).

In Step (308), the TBA (380) is used to remove water from the H₂O₂ solution in water (140) as described in FIG. 1, and the TBA containing water stream (20) is recycled back to Step (306). The TBA-H₂O₂ (30) stream is fed to Step (310).

In Step (310), the TBA-H₂O₂ (30) reacts with propylene (350) and catalyst to form PO and water (400).

In Step (312), the main product PO and water (400) are separated and purified PO (370) formed. The TBA water mixture (20) is recycled back to Step (306).

As described in FIG. 3, because the TBA from Steps (308) and (312) of the HPPO plant is recycled back to Step (306) of the POTBA plant, this integration scheme eliminate the need of having a TBA separation and purification within the HPPO plant. Therefore, this disclosure provides for more integration of related chemicals plants to reduce capital and operating costs.

The disclosed method of forming a hydrogen peroxide solution in a non-aqueous solvent combines a non-aqueous solvent such as an alcohol with an aqueous hydrogen peroxide solution to form a first mixture, followed by removing water from the first mixture to obtain an non-aqueous solvent-based hydrogen peroxide solution sometimes referred to herein as the final or second mixture. Any aqueous hydrogen peroxide solution in any concentration can be used as a starting solution to prepare the non-aqueous hydrogen peroxide solution. For example, the starting H₂O₂ solutions in water can range from about 3 wt % to about 60 wt % H₂O₂ in water.

The concentration of the hydrogen peroxide in the final non-aqueous solvent-based hydrogen peroxide solution can range from about 1 wt % to about 70 wt % or even higher. The non-aqueous solvent can be an alcohol as described herein. As the skilled person will appreciate, caution should be used when preparing and handling H₂O₂ solutions that are more concentration than about 70 wt % H₂O₂.

In embodiments, the concentration of the hydrogen peroxide in the final non-aqueous solvent-based hydrogen peroxide solution such as an alcohol-hydrogen peroxide solution, can range from about 0.5 wt % to about 70 wt %, from about 1 wt % to about 60 wt %, from about 10 wt % to about 50 wt %, or from about 15 wt % to about 45 wt %. In embodiments, the concentration of the hydrogen peroxide in the final non-aqueous solvent-based hydrogen peroxide solution such as an alcohol-hydrogen peroxide solution, can be about 1 wt %, 2 wt %, 5 wt %, 10 wt %, 20 wt %, 30 wt %, 40 wt %, 50 wt %, 60 wt %, or even 70 wt %, including any ranges between any of these weight percentage numbers. Accordingly, the concentration of the alcohol or other non-aqueous solvent in the final non-aqueous solvent-based hydrogen peroxide solution can be about 99 wt %, 98 wt %, 95 wt %, 90 wt %, 80 wt %, 70 wt %, 60 wt %, 50 wt %, 40 wt %, or 30 wt %.

In the final non-aqueous solvent-based hydrogen peroxide solutions such as an alcohol-hydrogen peroxide solution, some water can be present. In embodiments, the water can be less than or equal to about 5 wt %, 4 wt %, 3 wt %, 2 wt %, or 1 wt % of the total non-aqueous solvent-based hydrogen peroxide solution.

Also in the final non-aqueous solvent-based hydrogen peroxide solution such as an alcohol-hydrogen peroxide solution, a certain concentration of various non-hydrogen peroxide and non-water contaminants can also be present. In embodiments, the final non-aqueous solvent-based hydrogen peroxide solution can contain less than or equal to about 3 wt %, 2.5 wt %, 2 wt %, 1.5 wt %, 1 wt %, or 0.5 wt % or other components.

In embodiments, the non-aqueous solvent selected for the process can be an alcohol which forms an azeotrope with water. In an aspect, the alcohol can have a boiling point lower than that of H₂O₂ at the same pressure, for example, at reduced pressure. In embodiments, the azeotropic mixture formed from the selected alcohol with H₂O also can have a boiling point lower than that of H₂O₂ at the same pressure. For example, the alcohol can be selected from a primary alcohol, a secondary alcohol, a tertiary alcohol, or a combination thereof, which has a boiling point lower than that of H₂O₂ at the same pressure.

In some embodiments, the alcohol can be selected from an alcohol that can have a boiling point at least 25° lower than the boiling point of H₂O₂, measured at standard pressure (1 atmosphere). In some embodiments, the alcohol can have a boiling point at least 30° lower, at least 35° lower, at least 35° lower, at least 40° lower, at least 45° lower, at least 50° lower, at least 55° lower, at least 60° lower, at least 65° lower, at least 70° lower, or at least 75° lower than the boiling point of H₂O₂, measured at standard pressure (1 atmosphere). When the non-aqueous solvent is not an alcohol, the non-aqueous solvent can have a boiling point lower than the boiling point of H₂O₂ by the same amounts disclosed here for an alcohol, when measured at 1 atmosphere pressure.

In other embodiments, the alcohol can be selected such that the azeotrope formed from the alcohol and water can have a boiling point at least 30° lower than the boiling point of H₂O₂, measured at standard pressure (1 atmosphere). In some embodiments, the azeotrope can have a boiling point at least 35° lower, at least 35° lower, at least 40° lower, at least 45° lower, at least 50° lower, at least 55° lower, at least 60° lower, at least 65° lower, at least 70° lower, or at least 75° lower than the boiling point of H₂O₂, measured at standard pressure (1 atmosphere). When the non-aqueous solvent is not an alcohol, the non-aqueous solvent can be selected such that the azeotrope formed from the solvent and water can have a boiling point lower than the boiling point of H₂O₂ by the same amounts disclosed here for the alcohol, when measured at 1 atmosphere pressure.

In embodiments, alcohols include, ethanol, n-propanol, iso-propanol, n-butanol, sec-butanol, iso-butanol, tert-butanol (TBA), neopentyl alcohol, tert-amyl alcohol, allyl alcohol, or any combination thereof.

It can be seen from the observed boiling points of the relevant compounds and the azeotropes that tert-butyl alcohol (TBA) works well in the disclosed process. The literature values for the boiling point of TBA at atmospheric pressure is 82.8° C., and pure water boils at 100° C. A TBA:water mixture having a TBA concentration of 88.3 wt % and a water concentration of 11.7 wt % forms an azeotrope having a boiling point of about 79.9° C. Therefore, both the non-aqueous solvent TBA and its azeotropic mixture with water boil at least 65° lower than the boiling point of H₂O₂, measured at 1 atmosphere pressure.

Non-aqueous solvents for the H₂O₂ solutions and processes disclosed herein can be selected for their solvation properties to achieve better solubility of non-polar components in polar H₂O₂ mixtures. In this aspect, non-aqueous solvents other than alcohols can be used in the processes to prepare H₂O₂ solutions as described herein. In embodiments, for example, non-aqueous and non-alcoholic solvents which can form low boiling point azeotropic mixtures with water which can be used include, for example: esters such as ethyl acetate or methyl acetate; aromatic compounds such as benzene or toluene; ethers such as diethyl ether or tetrahydrofuran; hydrocarbons such as cyclohexane; or nitriles such as acetonitrile.

### EXAMPLES

The hydrogen peroxide concentrations reported in the mixtures were analyzed using the iodometric titration method with an automatic titrator.

### Example 1

This example illustrates the process to replace the water in a H₂O₂ and water mixture with tert-butyl alcohol (TBA).

A 90 gram (g) portion of TBA is combined with 10 g of a 50 wt % H₂O₂ solution in water to form a first mixture. This first mixture is then distilled under vacuum conditions to provide 7.71 g of a second mixture in the bottom of the distillation flask containing 48.69 wt % hydrogen peroxide, 50.37 wt % TBA, and 0.94 wt % water. The 71.31 g sample of condensed distillate contained 2.05 wt % hydrogen peroxide and 4.8 wt % water with the balance being TBA, perhaps with minor amounts of decomposition products. The remaining hydrogen peroxide and water originally in the first mixture was in the non-condensed vapor stream.

The bottom product (second mixture) contained 48.69 wt % hydrogen peroxide, 50.37 wt % TBA, and 0.94 wt % water, therefore, most of the water in the original (first) mixture was removed by this process. The concentration of H₂O₂ in the bottom product (second mixture) can be adjusted to the desired value by using additional amounts of TBA to remove additional water, or by using less TBA to remove less water.

### Example 2

This process simulation example illustrates the impact of the TBA:H₂O ratio in the feed on the H₂O removal effectiveness or efficiency. In order to achieve low concentrations, that is less than 1 wt %, of water in the final TBA-hydrogen peroxide mixture (second mixture), the weight ratio of TBA to H₂O (TBA:H₂O; wt/wt) in the original feed (first mixture) can be about 18:1 or higher.

A typical distillation column used in this example has 10 trays, with the feed tray at 5, a reflux ratio at 1, a total condenser and a pressure at the condenser of 3 psia (pounds per square inch, ambient). The feed rate of a 50 wt % H₂O₂ in water solution was fixed at 10,000 lb/hr into mixing step 102. The TBA stream in this example contained 1% water. See FIG. 1.

Table 1 shows the results of this simulation example, namely, the water concentration in the final H₂O₂-TBA mixture (wt %) that is formed (second column) using increasing TBA:H₂O ratios (lb/lb) in the feed (first column).

TABLE 1
Water concentration in the final H₂O₂-TBA mixture
(wt %) formed using various TBA:H₂0 ratios (lb/lb)

| | Water concentration in the |
|---|---|
| TBA:H₂0 ratio in feed | final H₂O₂-TBA mixture |
| (lb/lb) | (wt %) |
| 2:1 | 38.9 |
| 4:1 | 28.4 |
| 6:1 | 19.1 |
| 8:1 | 11.4 |
| 10:1 | 6 |
| 12:1 | 3.17 |
| 14:1 | 1.91 |
| 16:1 | 1.31 |
| 18:1 | 0.98 |
| 20:1 | 0.77 |
| 22:1 | 0.64 |
| 24:1 | 0.55 |
| 26:1 | 0.47 |

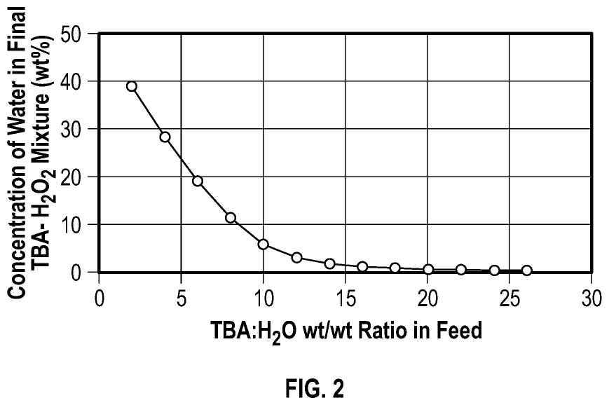

FIG. 2 illustrates a plot of the weight ratio of TBA to water in the feed (wt/wt) (x-axis) versus the concentration of water in the final TBA-H₂O₂ mixture (wt %) which is recorded in Table 1, showing how increasing the proportion of TBA added to an initial aqueous hydrogen peroxide solution removes increasing amounts of water to provide a final TBA-hydrogen peroxide solution with very low concentration of water.

### Example 3

This process simulation example illustrates the impact of the bottom flowrate to the final H₂O₂ concentration. A typical distillation column used in this example has 10 trays, with the feed tray at 5, reflux ratio at 1, a total condenser and pressure at the condenser of 3 psia. The total feed of 100,000 lb/hr consists of 10,000 lb/hr of 50 wt % H₂O₂ in water and 90,000 lb/hr TBA with 1% water.

TABLE 2
The H₂O₂ concentration in the final H₂O₂-TBA mixture
(wt %) as a function of bottom flowrate (lb/hr)

| | H₂O₂ concentration in the |
|---|---|
| Bottom flowrate | final H₂O₂-TBA mixture |
| (lb/hr) | (wt %) |
| 10,000 | 49.7 |
| 9,000 | 55.2 |
| 8,000 | 62.1 |
| 7,000 | 71.0 |

### Example 4

This process simulation example illustrates the impact of the column pressure to the bottom temperature. In an embodiment, the bottom temperature can be at about 60° C. or less, because higher temperature can lead to increasing H₂O₂ decomposition which can form oxygen and increase the safety risk of operating the system. A typical distillation column used in this example has 10 trays, with feed tray at 5, reflux ratio at 1, a total condenser and pressure at the condenser of 3 psia. The total feed of 100,000 lb/hr consists of 10,000 lb/hr of 50 wt % H₂O₂ in water and 90,000 lb/hr TBA with 1% water. The bottom flow rate is fixed at 10,000 lb/hr.

TABLE 3
The bottom temperature in an embodiment of the distillation
process of this disclosure as a function of column pressure
(psia, pounds per square inch, ambient pressure)

| Column pressure | Bottom temperature |
|---|---|
| (psia) | (° C.) |
| 3 | 58.6 |
| 4 | 63.3 |
| 5 | 67.3 |
| 6 | 70.8 |
| 7 | 73.9 |
| 8 | 76.7 |

Any publications that may be referenced throughout this specification are hereby incorporated by reference in pertinent part in order to more fully describe the state of the art to which the disclosed subject matter pertains. To the extent that any definition or usage provided by any document incorporated herein by reference conflicts with the definition or usage provided in this disclosure, the definition or usage provided in this disclosure controls.

For any particular compound disclosed herein, the general structure presented is also intended to encompasses conformational isomers and stereoisomers that can arise from a particular set of substituents, unless indicated otherwise. Thus, the general structure encompasses enantiomers, diastereomers, and other optical isomers whether in enantiomeric or racemic forms, as well as mixtures of stereoisomers, as the context permits. For any particular formula that is presented, any general formula presented also encompasses conformational isomers, regioisomers, and stereoisomers that can arise from a particular set of substituents. Accordingly, Applicant reserves the right to proviso out any particular individual isomer or isomers, if for any reason Applicant chooses to claim less than the full measure of the disclosure, for example, to account for a reference that Applicant is unaware of at the time of the filing of the application.

As used in the specification and the claims, the singular forms “a,” “an,” and “the” include plural referents unless the context indicates otherwise. Thus, for example, “a compound” includes mixtures of two or more such compounds, “the composition” includes mixtures of two or more such compositions, and the like.

Terms such as “configured for”, “adapted for”, “adapted to” and similar language is used herein to reflect that the particular recited structure or procedure is used in the recited mixing and separation steps of the disclosed process. For example, unless otherwise specified, a particular structure “configured for use” means it is “configured for use in chemical facility” for the process disclosed herein, therefore is designed, shaped, arranged, constructed, and/or tailored to effect the relevant disclosed mixing and separation steps, as would have been understood by the skilled person.

“Optional” or “optionally” means that the subsequently described event or circumstance can or cannot occur, and that the description includes instances where the event or circumstance occurs and instances where it does not.

Unless indicated otherwise, when a range of any type is disclosed or claimed, for example a range of the percentages, it is intended to disclose or claim individually each possible number that such a range could reasonably encompass, including any sub-ranges or combinations of sub-ranges encompassed therein. When describing a range of measurements such as these, each possible number that such a range could reasonably encompass can, for example, refer to values within the range with one significant figure more than is present in the end points of a range, or refer to values within the range with the same number of significant figures as the end point with the most significant figures, as the context indicates or permits. For example, when describing a range of percentages such as from 85% to 95%, it is understood that this disclosure is intended to encompass each of 85%, 86%, 87%, 88%, 89%, 90%, 91%, 92%, 93%, 94%, and 95%, as well as any ranges, sub-ranges, and combinations of sub-ranges encompassed therein. Applicant's intent is that these two methods of describing the range are interchangeable. Accordingly, Applicant reserves the right to proviso out or exclude any individual members of any such group, including any sub-ranges or combinations of sub-ranges within the group, if for any reason Applicant chooses to claim less than the full measure of the disclosure, for example, to account for a reference that Applicant is unaware of at the time of the filing of the application.

Values or ranges may be expressed herein as “about”, from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed herein, and that each value is also herein disclosed as “about” that particular value in addition to the value itself. In aspects, “about” can be used to mean within 10% of the recited value, within 5% of the recited value, within 2% of the recited value, or within 1% of the recited value.

Any headings that are employed herein are not intended to be used to construe the scope of the claims or to limit the scope of the subject matter that is disclosed herein. Any use of the past tense to describe an example otherwise indicated as constructive or prophetic is not intended to reflect that the constructive or prophetic example has actually been carried out.

Those skilled in the art will readily appreciate that many modifications are possible in the exemplary embodiments disclosed herein without materially departing from the novel teachings and benefits according to this disclosure. Accordingly, such modifications and equivalents are intended to be included within the scope of this disclosure as defined in the following claims. Therefore, it is to be understood that resort can be had to various other aspects, embodiments, modifications, and equivalents thereof which, after reading the description herein, may suggest themselves to one of ordinary skill in the art without departing from the spirit of the present disclosure or the scope of the appended claims.

Applicants reserve the right to proviso out any selection, feature, range, element, or aspect, for example, to limit the scope of any claim to account for a prior disclosure of which Applicants may be unaware.

The following numbered claims of this disclosure are provided, which state various attributes, features, and embodiments of the present disclosure both independently, or in any combination when the context allows. That is, as the context allows, any single numbered aspect or claim and any combination of the following numbered aspects or claims provide various attributes, features, and embodiments of the present disclosure.

We claim:

1. A continuous process for making a non-aqueous hydrogen peroxide solution, the process comprising:
a) combining a fresh non-aqueous solvent stream and an aqueous hydrogen peroxide solution stream in a mixing vessel to form a first mixture (10) comprising the non-aqueous solvent, hydrogen peroxide, and water, each having a respective concentration in the first mixture (10);
b) separating the first mixture into [1] a first stream (20) comprising a first portion of the non-aqueous solvent and a majority of the water present in the first mixture and [2] a second stream (30) comprising a second portion of the non-aqueous solvent and a majority of the hydrogen peroxide present in the first mixture; and
c) separating the first stream (20) into a non-aqueous solvent fraction and a water fraction.

2. The continuous process according to claim 1, further comprising the step of: d) recycling at least a portion of the non-aqueous solvent fraction of the first stream (20) into the fresh non-aqueous solvent stream of step a).

3. The continuous process according to claim 1, further comprising the step of:
e) combining at least a portion of the non-aqueous solvent fraction of the first stream (20) with the second stream (30) to form a second mixture (40) comprising the non-aqueous solvent and hydrogen peroxide, wherein the hydrogen peroxide is present in a lower concentration in the second mixture (40) than in the second stream (30).

4. The continuous process according to claim 1, wherein step b) of separating the first mixture (10) into a first stream (20) and a second stream (30) comprises an azeotropic distillation of the first mixture (10) to provide the first stream (20) as an overhead fraction and the second stream (30) as a bottom fraction in the distillation process.

5. The continuous process according to claim 4, wherein the azeotropic distillation is conducted under vacuum.

6. The continuous process according to claim 1, wherein the non-aqueous solvent comprises an alcohol which forms an azeotrope with water.

7. The continuous process according to claim 6, wherein the alcohol has a boiling point at least 30° lower than the boiling point of H₂O₂ when measured at 1 atmosphere pressure.

8. The continuous process according to claim 6, wherein the alcohol is selected from methanol, ethanol, n-propanol, iso-propanol, n-butanol, sec-butanol, iso-butanol, tert-butanol (TBA), neopentyl alcohol, tert-amyl alcohol, allyl alcohol, or any combination thereof.

9. The continuous process according to claim 6, wherein the alcohol concentration in the first mixture (10) is greater than or equal to a concentration to provide a second stream (30) comprising less than or equal to 1 wt % water.

10. The continuous process according to claim 6, wherein the alcohol-to-water ratio in the first mixture (10) is at least 18:1 (wt/wt).

11. A chemical facility comprising:
a) a first mixing vessel having a first mixing vessel discharge port, the first mixing vessel in fluid communication with a fresh non-aqueous solvent source and an aqueous hydrogen peroxide solution source, wherein a first mixture (10) comprising the non-aqueous solvent, hydrogen peroxide, and water, each having a respective concentration in the first mixture (10), is formed in the first mixing vessel;
b) a distillation unit configured to receive the first mixture (10) from the first mixing vessel discharge port and effect an azeotropic distillation of the first mixture (10) to provide a first stream (20) as an overhead fraction and a second stream (30) as a bottom fraction in the distillation unit; and
c) a separation unit configured to receive the first stream (20) from the distillation unit and separate the first stream (20) into a non-aqueous solvent fraction and a water fraction.

12. The chemical facility according to claim 11, wherein the separation unit is configured to return at least a portion of the non-aqueous solvent fraction into the fresh non-aqueous solvent source of step a).

13. The chemical facility according to claim 11, further comprising:
d) a second mixing vessel configured to receive the second stream (30) from the distillation unit and at least a portion of the non-aqueous solvent fraction of the first stream (20) to form a second mixture (40) comprising the non-aqueous solvent and hydrogen peroxide, wherein the hydrogen peroxide is present in a lower concentration in the second mixture (40) than in the second stream (30).

14. The chemical facility according to claim 11, wherein the azeotropic distillation is conducted under vacuum.

15. The chemical facility according to claim 11, wherein the non-aqueous solvent comprises an alcohol which forms an azeotrope with water.

16. The chemical facility according to claim 15, wherein the alcohol has a boiling point at least 30° lower than the boiling point of H₂O₂ when measured at 1 atmosphere pressure.

17. The chemical facility according to claim 15, wherein the alcohol is selected from methanol, ethanol, n-propanol, iso-propanol, n-butanol, sec-butanol, iso-butanol, tert-butanol (TBA), neopentyl alcohol, tert-amyl alcohol, allyl alcohol, or any combination thereof.

18. The chemical facility according to claim 15, wherein the alcohol concentration in the first mixture (10) is greater than or equal to a concentration to provide a second stream (30) comprising less than or equal to 1 wt % water.

19. The chemical facility according to claim 15, wherein the alcohol-to-water ratio in the first mixture (10) is at least 18:1 (wt/wt).

20. A method of making a hydrogen peroxide solution, the method comprising:
a) combining tert-butyl alcohol and an aqueous hydrogen peroxide solution to form a first mixture comprising tert-butyl alcohol, hydrogen peroxide, and water, wherein the tert-butyl alcohol-to-water ratio in the first mixture is at least 18:1 (wt/wt); and
b) removing water from the first mixture by an azeotropic distillation under vacuum to obtain a tert-butyl alcohol-based hydrogen peroxide solution comprising less than 1 wt % water.
